(19) United States
(12) Patent Application Publication
(10) Pub. No.: US 2002/0062486 A1
(43) Pub. Date: May 23, 2002

(54) Cable modem network system and method for selecting upstream channel in cable modem

(75) Inventor: Min Young Park, Seongnam (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 10/001,021

(22) Filed: Nov. 2, 2001

(30) Foreign Application Priority Data
Nov. 18, 2000 (KR) 68665/2000

(51) Int. Cl. H04N 7/173; H04J 3/16

(52) U.S. Cl. 725/111; 725/120; 370/437

(57) ABSTRACT

In a cable modem network system and a method for selecting an upstream channel in a cable modem, a time required for an initialization of a cable modem can be reduced by grouping cable modems by a certain units and selecting an upstream channel on the basis of upstream channel group information and preset upstream channel information. A cable modem network system includes a CMTS (cable modem termination system) grouping cable modems by a certain units and transmitting UCDs (upstream channel descriptors) information including upstream channel group information according to the grouping and a cable modem selecting an upstream channel on the basis of the upstream channel group information included in the UCDs information and preset upstream channel information.

### BACKGROUND OF THE INVENTION

1. Field of the Invention

The present invention relates to a cable modem network system, and in particular to a cable modem network system and a method for selecting an upstream channel in a cable modem which are capable of selecting an upstream channel in an initialization process of a cable modem.

2. Description of the Prior Art

Generally, a cable modem transmits/receives various information through a cable modem network. Herein, the cable modem network can be classified into a cable modem (CM) and a CMTS (cable modem termination system).

The CMTS receives a signal (upstream) transmitted from a cable modem of each home and transmits a data signal (downstream) to the cable modem of each home. Herein, the downstream transmitted from the CMTS includes MAC (media access control) management messages for controlling a cable media commonly used in a plurality of cable modems. The cable modem obtains information about its operation method by using the MAC (media access control) management messages.

Recently, a cable modem transmission standard standardized in the US is stated minutely in DOCSIS (data-over-cable service interface specification), an initialization process for selecting an upstream channel of a cable modem according to the standard will be described.

First, a receivable downstream channel is searched and selected. A cable modem of a management message and a CMTS are synchronized by receiving a SYNC message of the selected downstream channel.

After, when the synchronization is finished, the cable modem receives a UCD (upstream channel descriptor) message having information about an upstream channel for transmitting data from the selected downstream channel. Because the UCD message has to transmit information about all usable upstream channels to the cable modem receiving one downstream, generally not a UCD but a plurality of UCDs are transmitted to each cable modem from the CMTS.

The cable modem receives all UCD messages obtainable from the selected downstream channel and selects a random upstream channel in the all received UCD messages. In more detail, by using the selected random upstream channel, the cable modem transmits data to be transmitted.

As described in the selection initialization process of the upstream channel, the cable modem selects a random upstream channel of the UCDs from the selected downstream channel. And, the cable modem to transmit data is unaware whether the selected upstream channel is in a usage state. Therefore, by transmitting a “ranging request” to the CMTS by using the selected random upstream channel, the cable modem checks whether the selected upstream channel is in the usage state. Hereinafter, an upstream channel selecting process according to a method for selecting an upstream channel in a cable modem in accordance with the prior art will be described with reference to accompanying FIG. 1.

FIG. 1 conceptually illustrates an upstream channel selecting process according to a method for selecting an upstream channel in a cable modem in accordance with the prior art.

As depicted in FIG. 1, when a selected upstream channel (channel A) does not use a present cable modem, upstream channel change information is received through “ranging response” about the “ranging request” transmitted from the CMTS.

After, when the cable modem has to change the first selected upstream channel (channel A) to another upstream channel (channel B), “ranging request” is transmitted again to the CMTS through the changed upstream channel and it is checked whether the changed upstream channel (channel B) is usable.

Accordingly, because the cable modem has to check whether the first selected upstream channel is usable, a proceeding time of the initialization process of the cable modem is lengthened. Accordingly, because a user using the cable modem has to wait long time for checking a usable upstream channel, it is inconvenient for the user.

### SUMMARY OF THE INVENTION

Accordingly, it is an object of the present invention to provide a cable modem network and a method for selecting an upstream channel in a cable modem which are capable of reducing a time required in an initialization of a cable modem by grouping cable modems by a certain unit and selecting an upstream channel on the basis of upstream channel group information and preset upstream channel information.

In order to achieve the above-mentioned object, a cable modem network system in accordance with the present invention includes a CMTS (cable modem termination system) grouping cable modems by a certain units and transmitting UCDs (upstream channel descriptors) information having upstream channel group information and a cable modem selecting an upstream channel on the basis of upstream channel group information included in the UCDs information and preset upstream channel information.

In order to achieve the above-mentioned object, a method for selecting an upstream channel in a cable modem in accordance with the present invention includes receiving UCS information corresponded to upstream channel group information pre-stored in a cable modem from UCD (upstream channel descriptor) information transmitted from a CMTS (cable modem termination system) and, selecting an upstream channel on the basis of the received UCD information.

### BRIEF DESCRIPTION OF THE DRAWINGS

FIG. 1 conceptually illustrates an upstream channel selecting process according to a method for selecting an upstream channel in a cable modem in accordance with the prior art.

FIG. 2 illustrates a cable modem network system in accordance with the present invention.

FIG. 3 illustrates an encoding method of a UCD.

FIG. 4 illustrates channel and burst description information included in a general UCD encoding method.

FIG. 5 illustrates a channel included in a UCD encoding method and burst description information in a system using a method for selecting an upstream channel in a cable modem in accordance with the present invention.

FIG. 6 is a block diagram illustrating a construction of a cable modem in a system using a method for selecting an upstream channel in a cable modem in accordance with the present invention.

### DETAILED DESCRIPTION OF THE PREFERRED EMBODIMENT

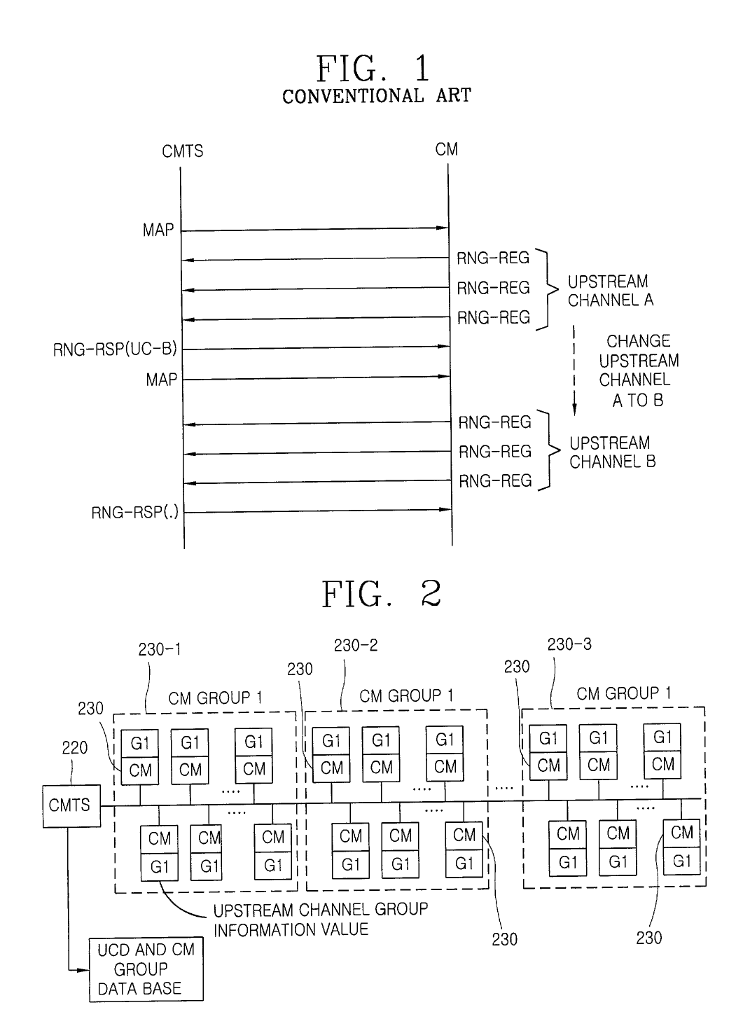

Hereinafter, preferred embodiments of a cable modem network system and a method for selecting an upstream channel in a cable modem in accordance with the present invention will be described in detail with reference to accompanying FIGS. 2˜6.

FIG. 2 illustrates a cable modem network system in accordance with the present invention. In more detail, it illustrates a system being applied a method for selecting an upstream channel in a cable modem.

As depicted in FIG. 2, the cable modem network system in accordance with the present invention includes a database 210 grouping cable modems 230 by a certain unit and storing group information of a group included in the grouped cable modems and UCDs (upstream channel descriptors) allocated to the cable modems 230 included in the group, a CMTS (cable modem termination system) 220 transmitting a UCDs message (UCDs information) adding upstream channel group information of the cable modems 230 included in the group to the UCDs on the basis of the group information and the UCDs and cable modems 230 connected to the CMTS 220 through cables, receiving the UCDs (upstream channel descriptors) message and selecting an upstream channel. The operation of the cable modem network system in accordance with the present invention will be described in detail.

First, the cable modems 230 are grouped by several units (230-1, 230-2, . . . , 230-n), proper group information of the groups (230-1, 230-2, . . . , 230-n) are set and allocated. Herein, the cable modems 230 are grouped by a certain units according to a distance from the CMTS 220 or regional characteristics or various standards.

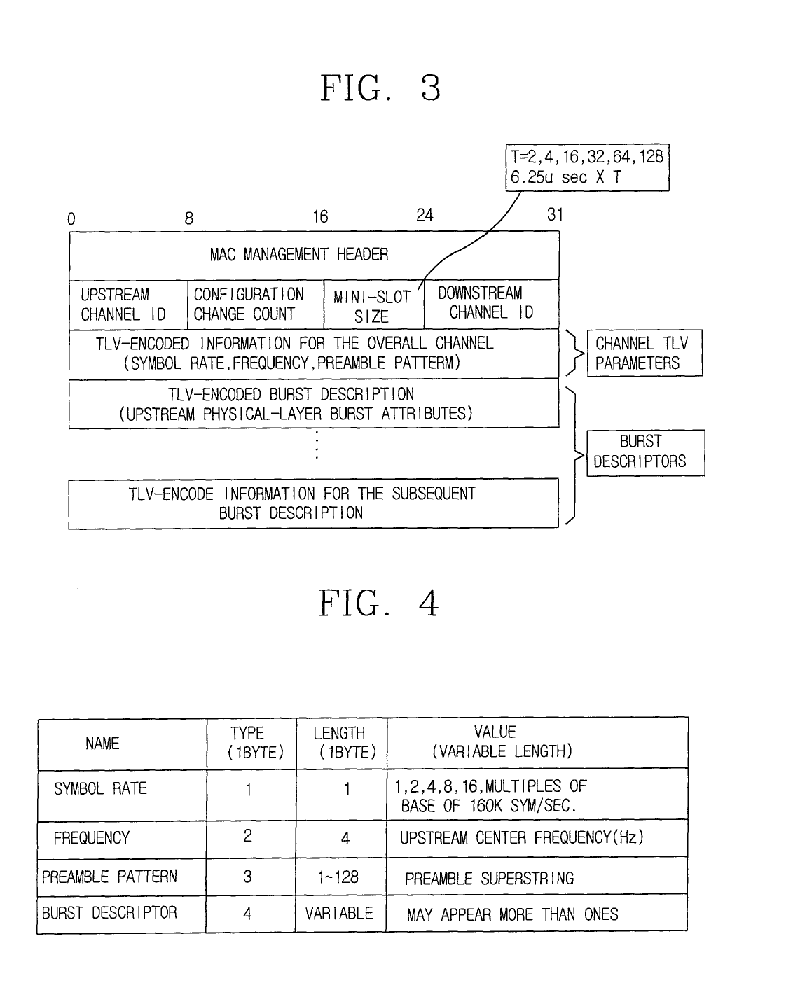

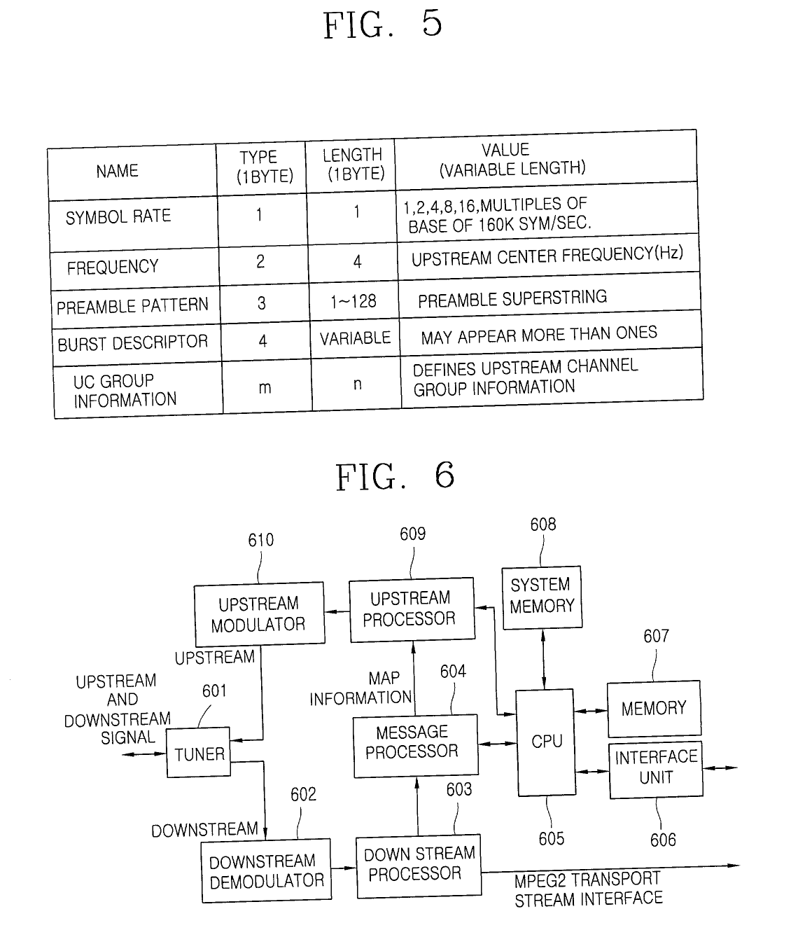

In the meantime, the CMTS (cable modem termination system) 220 is connected to the database 210 storing the set group information and UCDs allocated to cable modems 230 of each group. In addition, the CMTS 220 receives to the set group information and the UCDs from the database 210, makes out a UCDs message (UCDs information) and encodes the UCDs message as a format shown at FIG. 3. Herein, FIG. 3 illustrates an encoding method of a UCD. FIG. 4 illustrates channel and burst description information included in a general UCD encoding method. FIG. 5 illustrates a channel and burst description information included in a UCD encoding method in a system using a method for selecting an upstream channel in a cable modem in accordance with the present invention.

In the meantime, in encoding of the UCD, besides information shown at FIG. 4, as depicted in FIG. 5, the CMTS 220 in accordance with the present invention transmits upstream channel group information with the UCDs message to each cable modem connected to a cable network. Herein, the upstream channel group information is constructed as a format such as a symbol rate, a frequency, a preamble pattern, a burst descriptor of another UCD. And, a first byte describes type information in order to be sorted from another information, a second byte describes a length of a value part, and a third byte includes practical contents of the information at the value part. Herein, the value part storing group information as the practical information is constructed with variable data determined according to a length value. In addition, the type part of the upstream channel group information has a m value, and the length part has a n value. And, a length of the value part is n byte, and the n byte shows the whole cable modem group information of the cable modem network system.

In the meantime, when the CMTS 220 transmits UCDs information shown at FIG. 3 to the cable modem through a downstream channel as contents described in FIG. 5, the initialization process proceeds by receiving the UCDs information in the initialization process of the cable modems 230.

In addition, the cable modems 230 in accordance with the present invention includes a memory (non-volatile memory) storing the upstream channel group information. The upstream channel group information memory 607 stores an upstream channel group information value including a present cable modem. In more detail, the upstream channel group information value is stored in the memory 607 of the cable modem in installation of the cable modem.

After, the cable modems storing the upstream channel information value receives a SYNC MAC (media access control) management message transmitting information in a synchronous part and a UCD MAC management message as upstream channel information (which means the cable modem can transmit data) through a downstream channel. Herein, the UCD information (UCDs message) received to the cable modem includes upstream channel group information shown at FIG. 5, the cable modem compares the upstream channel group information value stored in the cable modem with the upstream channel group information value in the received UCD information.

The cable modem selects a UCD having a coincided upstream channel group information value by comparing the stored upstream channel group information value with the upstream channel group information value in the received UCD, and uses the upstream channel defined in the selected UCD as an upstream value in early stage.

As described above, when the cable modem 230 is installed already, the upstream channel group information is stored in the memory 607 of the cable modem, a preponderance phenomenon massing in one upstream channel can be prevented from occurring, because an upstream channel to be used by cable modems of one group is already determined, an initial ranging process is performed only one time, accordingly a time required for the initialization of the cable modem can be reduced. Hereinafter, in a system using a method for selecting an upstream channel in a cable modem in accordance with the present invention, the construction of the cable modem will be described in detail with reference to accompanying FIG. 6.

FIG. 6 is a block diagram illustrating a construction of a cable modem in a system using a method for selecting an upstream channel in a cable modem in accordance with the present invention.

As depicted in FIG. 6, the cable modem 230 includes a non-volatile memory 607 storing upstream channel group information, a tuner 601 selecting a random downstream, a downstream demodulator 602 obtaining synchronous data by receiving a SYNC MAC management message from the selected downstream and receiving UCDs message (UCDs information) from the CMTS 220, a downstream processor 603, a message processor 604, and a CPU 605 checking whether a group including a present cable modem is a descriptor about an upstream channel to be used by parsing the received UCDs message. Herein, the CPU 605 compares an upstream channel group information value in the received UCDs information with the upstream channel group information value stored in the memory 607 of the cable modem, selects a UCD value having a coincided upstream channel group information value, selects an upstream channel defined by the selected UCD and transmits data to the CMTS 220 through the selected upstream channel.

On the contrary, the CPU 605 compares the upstream channel group information in the received UCDs information with the upstream channel group information stored in the memory 607 of the cable modem, when they do not coincide, the CPU 605 receives UCD continuously until a UCD having a coincided upstream channel group information value is recieved. Herein, for example, an interface unit 606 of the cable modem 230 transmits/receives IP data by being connected to a terminal such as a PC through an Ethernet or another interface (USB).

In the meantime, a system memory 608, an upstream processor 609 and an upstream modulator 610 are general construction parts, description about them will be abridged. Hereinafter, the operation of the construction excluding the system memory 608, the upstream processor 609 and the upstream modulator 610 will be described in detail.

First, the memory 607 of the cable modem 230 stores upstream channel group information to be used by a group including the cable modem 230, and the tuner 601 selects a random down steam.

After, the CPU 605 obtains synchronous data by receiving a SYNC MAC management message from the selected down stream through the downstream demodulator 602, the downstream processor 603 and the message processor 604, and receives the UCDs message from the CMTS 220. In addition, the CPU 605 checks whether the group in which the present cable modem is included is a descriptor about an upstream channel to be used by parsing the received UCDs message. In more detail, the CPU 605 compares the upstream channel group information value in the received UCDs message with the upstream channel group information value stored in the memory 607 of the cable modem 230, when they coincide with each other, an upstream channel is selected from the UCD having the coincided upstream channel group information value, and data is transmitted to the CMTS 220 through the selected upstream channel. On the contrary, the CPU 605 compares the upstream channel group information value in the received UCDs information with the upstream channel group information value stored in the memory 607 of the cable modem, when they do not coincide with each other, UCD is received consecutively until an USD having a coincided upstream channel group information value is received.

In the meantime, the CMTS 220 can adjust information defined already in the cable modem group information database at need and request change of an upstream channel used previously in the cable modem by using the adjusted value.

By determining an upstream channel to be used with the above-mentioned method, a time required for selecting an upstream channel can be reduced to the utmost, and contention between other cable modems can be decreased to the utmost. In more detail, in installation of the cable modem, cable modem group information is set in the cable modem, information about an upstream channel to be used by the group is stored in the database 210, accordingly a time required for initialization of the cable modem can be reduced to the utmost and efficiency of the upstream channel of a cable network can be optimized.

As described above, the cable modem network system and the method for selecting the upstream channel in the cable modem can reduce a time required for initialization of the cable modem by selecting an upstream channel on the basis of upstream channel information transmitted from the CMTS 220 and upstream channel information stored in the cable modem in the initialization of the cable modem.

What is claimed is:

1. A cable modem network system, comprising:
a CMTS (cable modem termination system) grouping cable modems by a certain units and transmitting UCDs (upstream channel descriptors) information including upstream channel group information according to the grouping; and
a cable modem selecting an upstream channel on the basis of the upstream channel group information included in the UCDs information and preset upstream channel information.

2. The cable modem network system according to claim 1, wherein the upstream channel group information and the UCDs information are stored in a database.

3. The cable modem network system according to claim 1, wherein the preset upstream channel information is stored in a memory.

4. The cable modem network system according to claim 3, wherein the memory is a non-volatile memory.

5. The cable modem network system according to claim 1, wherein the cable modem includes a CPU (Central Processing Unit) selecting an upstream channel of the coincided upstream channel group information when the upstream channel group information of the received UCDs information is compared and coincides with the preset upstream channel information.

6. The cable modem network system according to claim 5, wherein the CPU transmits data to the CMTS through the selected upstream channel.

7. The cable modem network system according to claim 5, wherein the CPU receives a UCD consecutively until a coincided UCD is received when the upstream channel group information is compared and does not coincide with the preset upstream channel information.

8. The cable modem network system according to claim 1, wherein the cable modem selects a UCD value having coincided upstream channel group information by comparing the upstream channel group information of the received UCDs information with the upstream channel group information stored in the memory of the cable modem, selects an upstream channel defined by the selected UCD and transmits data to the CMTS through the selected upstream channel.

9. The cable modem network system according to claim 1, wherein the cable modems are grouped by a certain units according to a distance from the CMTS or regional characteristics.

10. In a cable modem transmitting/receiving data to/from a CMTS (cable modem termination system) through a cable, the cable modem, comprising:
a memory grouping cable modems by a certain units and storing upstream channel group information according to the grouping; and
a CPU (Central Processing Unit) selecting an upstream channel on the basis of upstream channel group information outputted from the CMTS and the stored upstream channel information.

11. The cable modem according to claim 10, wherein the memory is a non-volatile memory.

12. The cable modem according to claim 10, wherein the CPU selects an upstream channel of coincided upstream channel group information when the received upstream channel group information is compared and coincides with the stored upstream channel information.

13. The cable modem according to claim 10, wherein the CPU transmits data to the CMTS through the selected upstream channel.

14. The cable modem according to claim 10, wherein the CPU compares the upstream channel group information from the CMTS with the stored upstream channel group information, selects a UCD (upstream channel descriptor) value having coincided upstream channel group information, selects an upstream channel defined by the selected UCD and transmits data to the CMTS through the selected upstream channel.

15. The cable modem according to claim 14, wherein the UCD value is outputted from the CMTS.

16. The cable modem according to claim 10, wherein the CPU consecutively receives UCDs (upstream channel descriptors) information including the upstream channel group information until coincided upstream channel information is received when the upstream channel group information is compared and does not coincide with the stored upstream channel information.

17. The cable modem according to claim 10, wherein the cable modems are grouped by a certain units according to a distance from the CMTS or regional characteristics.

18. A method for selecting an upstream channel in a cable modem, comprising:
grouping cable modems by a certain units and setting upstream channel group information according to the grouping; and
selecting an upstream channel on the basis of the upstream channel group information set by the CMTS and preset upstream channel information.

19. The method of claim 18, wherein the cable modems are grouped by a certain units according to a distance form the CMTS or regional characteristics.

20. The method of claim 18, wherein an upstream channel of coincided upstream channel group information is selected when the received upstream channel group information is compared and coincides with the preset upstream channel information in the upstream channel selecting step.

21. The method of claim 18, wherein a UCD value having coincided upstream channel group information is selected by comparing the upstream channel group information with the preset upstream channel group information, and an upstream channel defined by the selected UCD is selected in the upstream channel selecting step.

22. The method of claim 18, wherein UCDs information including the upstream channel group information is consecutively received from the CMTS until coincided upstream channel information is received in the upstream channel selecting step when the upstream channel group information is compared and does not coincide with the present upstream channel information.

23. A method for selecting an upstream channel in a cable modem, comprising:
receiving UCD (upstream channel descriptor) information corresponded to upstream channel group information pre-stored in a cable modem from UCD information transmitted from a CMTS (cable modem termination system); and
selecting an upstream channel on the basis of the received UCD information.

24. The method of claim 23, wherein the UCD information includes upstream channel group information allocated after grouping cable modems by a certain units.

25. The method of claim 23, wherein the upstream channel group information included in the UCD information is constructed with a type (1 byte), a length (1 byte) and a value (variable length).

26. The method of claim 23, wherein the value part storing a value about group information of the upstream channel group information is variable data determined according to a value of the length.

27. The method of claim 23, wherein the cable modems are grouped by a certain units according to a distance from the CMTS or regional characteristics.
